(19) United States
(12) Patent Application Publication
(10) Pub. No.: US 2008/0171191 A1
(43) Pub. Date: Jul. 17, 2008

(54) Preparation of polydiacetylene coatings

(75) Inventors: Mary A. Reppy, Wilmington, DE (US); Bradford A. Pindzola, Wilmington, DE (US); Stephen L. Hussey, New Castle, DE (US)

Correspondence Address: CONNOLLY BOVE LODGE & HUTZ LLP, 1875 EYE STREET, N.W., SUITE 1100, WASHINGTON, DC, 20036, US

(73) Assignee: Analytical Biological Services, Inc., Wilmington, DE (US)

(21) Appl. No.: 11/653,260

(22) Filed: Jan. 16, 2007

(51) Int. Cl. B32B 3/26; B05D 5/00

(52) U.S. Cl. 428/315.7; 427/296; 427/400

(57) ABSTRACT

Polydiacetylene (PDA) coatings are fabricated on porous membranes, specifically on membranes that have been pretreated or post treated by exposure to additional materials. In addition, the surface of the deposited diacetylene and PDA coatings can be modified.

### FEDERALLY SPONSORED RESEARCH OR DEVELOPMENT

Inventions in this disclosure are partially supported by a Phase II SBIR grant from the National Science Foundation (DMI-0239587) and a Phase II STTR grant from the Army Research Office (W911NF-O4-C-0132).

### TECHNICAL FIELD

The present disclosure relates to methods for preparing polydiacetylene coatings on pretreated filter membranes and post-deposition modifications of the coatings. Nano to microporous filter membranes are pretreated by exposure to polyelectrolyte solutions and/or protein solutions prior to deposition of diacetylene particles on the membranes. The particles form coatings that are polymerized through exposure to irradiation such as UV light or gamma irradiation to generate polydiacetylene coatings. The coatings can be readily and easily functionalized to add ligands or substrates for the detection of analytes; functionalization is facilitated by the ability to easily separate the reactants from the coatings by decanting the reactive solutions, without having to resort to chromatography or dialysis.

### BACKGROUND

Diacetylene and polydiacetylene arrays are disclosed in PCT/US01/008790; U.S. Pat. No. 6,984,528; U.S. Patent Application Publication U.S. 2004-0023303; and PCT/US05/28082; all of which are assigned to Analytical Biological Services, Inc. and also discussed in Pindzola B. A. et al, Chem. Comm. 2006, 906-908, and in Reppy et al, Abstract of the Material Research Society, Spring 2005, Symposium AA, p 588, by the inventors of this application, the disclosures of which are incorporated herein by reference.

Polydiacetylene coated filter membranes, including those of this disclosure, can be used for detecting an analyte in a sample by measuring a change in fluorescence and/or phosphorescence of the coating. Also, polydiacetylene coated filter membranes can be used for evaluating at least one of the ionization state of a compound, the volume of distribution of a compound, the distribution of a compound into different tissues, the ability of a compound to diffuse into cell membranes and the partitioning of a compound into cell organelles, by measuring the effect on the array from exposure to the compound by detecting the change in fluorescence or phosphorescence of the coating. Polydiacetylene coated filter membranes can be used for detecting the concentration of a known species by measuring a change in fluorescence and/or phosphorescence of the coating upon exposure to the species.

The advantages of preparing polydiacetylene coatings on porous membranes are that the user can direct analyte solution past the sensing materials and thus improve contact by filtering the analyte solution through the membrane (Dai J. et al. Anal. Chem. 2006, 78(1), 135-140) and can also concentrate analytes that are larger than the membrane pore size at the membrane surface where the sensing materials are located.

### SUMMARY OF DISCLOSURE

The present disclosure relates to the formation of polydiacetylene (PDA) coatings on porous membranes, specifically on membranes that have been pretreated by exposure to additional materials. Another aspect of the disclosure relates to modification of the surface of deposited diacetylene and PDA coatings. Polydiacetylene coated filter membranes of this disclosure can be used for the purposes disclosed herein above.

One aspect of the present invention relates to a method for fabricating a coating comprising polydiacetylene on a porous solid support which method comprises:
a) obtaining a porous solid support having a layer of polyelectrolyte on at least one major surface of the porous solid support,
b) depositing an unpolymerized precursor diacetylene onto the at least one major surface of the porous solid support to form a coating of the unpolymerized precursor diacetylene; and
c) polymerizing the unpolymerized precursor diacetylene.

Another aspect of the present disclosure relates to a method for fabricating a coating comprising polydiacetylene on a porous solid support which method comprises:
a) obtaining a porous solid support having a layer of polyelectrolyte on at least one major surface of the porous solid support and a layer of protein on the layer of polyelectrolyte;
b) then depositing an unpolymerized precursor diacetylene onto the at least one major surface of the porous solid support to form a coating of the unpolymerized precursor diacetylene; and
c) polymerizing the unpolymerized precursor diacetylene.

A still further aspect of the present disclosure relates to products obtained by the above methods wherein the porous solid substrate has a pore size of at least about 0.4μ.

The present disclosure also relates to a method for fabricating a coating comprising polydiacetylene on a porous solid support which method comprises:
a. depositing an unpolymerized precursor diacetylene onto at least one major surface of a porous solid support to form a coating of the unpolymerized precursor diacetylene;
b. then depositing a substrate or ligand that has direct affinity for an analyte or can function as a binder to an analyte or can react with an analyte; and
c. polymerizing the unpolymerized precursor diacetylene. The substrate or ligand is deposited prior to and/or during and/or subsequent to the polymerization of the unpolymerized precursor diacetylene.

A still further aspect of the present disclosure relates to products obtained by the above method.

In addition, the present disclosure relates to an article comprising a porous solid support having a layer of polyelectrolyte on at least one major surface thereof, support and a layer of protein on the layer of polyelectrolyte; and a polydiacetylene on the layer of protein, and wherein the porous solid substrate has a pore size of at least about 0.4μ.

Also, the present disclosure relates to an article comprising a porous solid support having a layer of polyelectrolyte on at least one major surface thereof, and a polydiacetylene on the layer of polyelectrolyte, and wherein the porous solid substrate has a pore size of at least about 0.4μ.

The present disclosure also is concerned with a product that comprises a porous solid support having a layer of a polydiacetylene located on the at least one major surface of the porous solid support; and a substrate or ligand that has direct affinity for an analyte or can function as a binder to an analyte or can react with an analyte located on the layer of a polydiacetylene.

The present disclosure also relates to methods of using the above disclosed products for the purposes disclosed above for polydiacetylene coated membranes.

Another aspect of the present disclosure is directed to an intermediate product that comprises a porous solid support having a layer of polyelectrolyte on at least one major surface of the porous solid support and an unpolymerized precursor diacetylene located on the layer of polyelectrolyte on the at least one major surface of the porous solid support.

A further aspect of the present disclosure relates to an intermediate product that comprises a porous solid support having a layer of polyelectrolyte on at least one major surface of the porous solid support, a layer of protein on the layer of polyelectrolyte and an unpolymerized precursor diacetylene located on the layer of protein.

Another aspect relates to intermediate product that comprises a porous solid support having a layer of an unpolymerized precursor diacetylene located on the at least one major surface of the porous solid support; and a substrate or ligand that has direct affinity for an analyte or can function as a binder to an analyte or can react with an analyte located on the unpolymerized precursor diacetylene.

Still other objects and advantages of the present disclosure will become readily apparent by those skilled in the art from the following detailed description, wherein it is shown and described only in the preferred embodiments, simply by way of illustration of the best mode. As will be realized, the disclosure is capable of other and different embodiments, and its several details are capable of modifications in various obvious respects, without departing from the spirit of the disclosure. Accordingly, the description is to be regarded as illustrative in nature and not as restricted.

### BRIEF DESCRIPTION OF DRAWINGS

FIGS. 1a-d show photographs of polymerized coated plates and filtrates according to the present disclosure.

FIG. 2 shows photographs of individual coated membranes.

FIGS. 3 a-f show TEMs of poly(PCDA) (10,12-pentacosadiynoic acid) coatings with and without antibodies, treated with secondary antibody-gold cluster conjugates prior to imaging.

FIGS. 4 a-d show TEMs of poly(P—PO4) (mono 10,12-pentacosadiynyl phosphate) coatings with and without antibodies, treated with secondary antibody-gold cluster conjugates prior to imaging.

### DESCRIPTION OF PREFERRED AND VARIOUS EMBODIMENTS

In order to facilitate an understanding of the present invention the following definitions which are used herein are presented:
Substrate: A chemical or biological entity that can undergo a chemical or biological reaction or process
Ligand: An entity that can interact with an analyte by a covalent or non-covalent binding interaction
Analyte: Any entity (physical, chemical or biological) that is to be detected

According to one aspect of the present disclosure, diacetylene particles, including liposomes, tubules, ribbons, fibers, sheets, micelles, bilayer structures, and other forms can be forced onto porous membranes with pore sizes ranging from 10 mm to 1μ and more specifically with pore sizes from 50 nm to 500 nm, and photopolymerized to create a PDA coating comprising an assembly of PDA polymers. These coated membranes may be stable at room temperature, in air, and exposed to light, for at least 12 months. The polydiacetylene coatings can be converted from the non-fluorescent to the fluorescent form or from one fluorescent form to another fluorescent form with a different magnitude of emission or the fluorescent to the non-fluorescent form in response to environmental changes including exposure to a solution containing a test compound or to a vapor. In other words, the fluorescence of the arrays can be either decreased or increased by exposure to the test compound or vapor. The color and absorbance of the coatings may be determined by eye, by image capture with a camera with and without software analysis, by reflectance UV-vis spectroscopy, or by ellipsometry, and used to characterize the effect upon the coating of test compound.

The diacetylene particles may contain ligands or substrates for analytes, and may incorporate other lipophilic species including natural and synthetic lipids, sterols, and cell membrane components. Appropriate compositions have been previously disclosed in U.S. Pat. No. 6,984,528. The optimal particle size varies according to the filter membrane characteristics and the particle compositions. Some optimal sizes for deposition on treated filter membranes are between 50 and 300 nm diameter and more particularly between 75 and 150 nm diameter.

Porous membranes are available in many materials, including: alumina, polyfluorocarbons such as Teflon® (polymers of tetrafluoroethylene), perfluorinated ethylene-propylene copolymers, copolymers of tetrafluoroethylene and perfluoroalkoxy, copolymers of tetrafluoroethylene and ethylene, polymers of chlorotrifluoroethylene, and copolymers of chlorotrifluoroethylene and ethylene; nylon, polycarbonate, cellulose, cellulose esters, mixed cellulose esters (MCE), polyvinylene difluoride (PVDF), hydrophilic PVDF (Durapore®), hydrophilic polypropylene and glass and also in a variety of pore sizes. Typically these membranes for purposes of the present disclosure for preparing coated PDA membranes have pore sizes up to about 500 nm. The membrane surfaces may be further modified by chemical, or plasma gas, or other, treatment, for example to make them hydrophilic, hydrophobic, to add charged groups or to graft polymers such as polyethylene glycol and polyethylene oxide. The membranes may be free standing or incorporated in a holder. Microtiter plates in 96-well and 384-well formats are available with porous membranes for well bottoms. Plates of any well number with porous membrane bottoms for coating deposition are suitable for purposes of this disclosure. Diacetylene coatings can be deposited on the membranes in these plates and photopolymerized; and these formats are suitable for use in assays performed in plate readers.

Particular membrane supports particularly appropriate for the disclosed method include mixed cellulose ester membranes (MCE), polyester membranes, nylon membranes, polycarbonate membranes, hydrophilic PVDF membranes, hydrophilic PTFE membranes, and hydrophilic polypropylene membranes.

According to one aspect of the present disclosure the porous membrane is treated prior to deposition of the diacetylene material. This pretreatment comprises depositing another material on the membrane. Deposited materials include polyelectrolyes, such as poly(lysine), poly(glutamic acid), poly(acrylic acid), poly(allylamine) and proteins such as bovine serum albumin (BSA) or other albumins or casein, or polyelectrolye followed by a protein. The deposited materials may be applied as layers. The diacetylenes may covalently bound to the functional groups of the deposited materials or interact through noncovalent interactions such as ionic, dipole and hydrogen bonding. For example, porous membranes can be coated with poly(lysine) or poly(glutamatic acid); diacetylene liposomes or other diacetylene particle solutions or suspensions are then filtered onto the coated membrane to form a diacetylene coating. As another example, porous membranes can be coated with poly(lysine) or poly(glutamatic acid) and then a protein such as bovine serum albumin (BSA) or other albumins or casein or other proteins, including other proteins used for blocking non-specific binding, is deposited; diacetylene liposomes or other diacetylene particle solutions or suspensions are then filtered onto the coated membrane to form a diacetylene coating. The poly(lysine) polyelectrolytes appropriate for the materials and methods of this disclosure are typically the hydrobromide salts, with molecular weights in the range 15,000-150,000 g/mol, and more typically with molecular weights in the range 70,000-150,000 g/mol.

The poly(electrolyte) treatment may allow deposition of diacetylene particles on membranes where the particles will not deposit on the untreated membrane. This is of particular utility in using membranes of larger pore size; for example some diacetylene particles will not deposit on membranes with pores sizes of 0.4μ or larger, however, treatment with a poly(electrolyte) prior to deposition leads to retention of the diacetylene on the membrane forming a coating. There can be an advantage in using membranes of larger pore size for coating supports as it is generally easier to filter solutions through coated membranes with larger pore sizes than through corresponding coated membranes of smaller pore sizes.

Deposition of the diacetylene coatings on membranes can be performed by pushing the solutions or suspensions of diacetylene particles through the membranes, or by pulling the solutions or suspensions of diacetylene particles through the membranes. As an example of the pushing method the solution or suspension of diacetylene particles is placed in a syringe and the syringe plunger is used to push the solution or suspension through a membrane mounted in a holder attached to the syringe with the liquid passing through and the diacetylene material depositing on the membrane. Another example of the pushing method is the solution or suspension of diacetylene particles is placed in the wells of a filter plate and a plunger is used to push the solution through the membrane. As an example of the pulling method, the solution or suspension is placed in the syringe, the membrane in its holder attached to the syringe, and suction applied to the outlet of the holder to pull the liquid through, depositing diacetylene material on the membranes. In another example of the pulling method, the solution or suspension is placed in the wells of a 96-well filter plate and suction is applied to the bottom of the plate to pull the liquid through. This can be achieved using a Millipore vacuum manifold designed for plate filtering and a water aspirator or vacuum pump to generate a reduced pressure. Reduced pressures suitable for suction include pressures from about 10 to about 650 Torr, and more specifically about 300-about 400 Torr or in certain embodiments from about 400 to about 650 Torr. Filtration of the solution through the membrane can also be achieved through centrifugation.

By way of example, the diacetylene coatings are photopolymerized with irradiation such as UV light, or gamma-radiation, to give organized polydiacetylenes with the longer conjugation lengths characterized by absorption maximum in the range of 500-800 nm, more typically in the range 600-750 nm, and a blue to purple color. The photopolymerization results in creating mainly the non-fluorescing form and therefore exhibiting low overall fluorescence relative to the background. The term “non-fluorescent form” as used herein also refers to these polymers which have low overall fluorescence exhibiting a fluorescent signal above 500 nm that is only about 1-3 times that of the background and less than that of the corresponding fluorescent form. The term “emission” as used herein refers to the intensity of fluorescence emitted at a wavelength or over a range of wavelengths. Typically the “non-fluorescent form” exhibits a fluorescent emission above 500 nm that is at least about 10% lower and more typically at least about 50% lower than that of the corresponding fluorescent form. Some diacetylene coatings give polydiacetylene in the fluorescent forms upon photopolymerization; these may be used in assays if interaction with a test compound converts the arrays to a fluorescing form having a different measurable emission that is either lower or higher than the original emission. Arrays may also be heated, subjected to extended UV irradiation, or exposed to other environmental changes, for example, a change in pH, to convert them to the fluorescent form before use in assays.

Another aspect of the present disclosure is that the coated diacetylene material may be modified after deposition either prior or post polymerization. Further chemistry can be performed on the diacetylene or polydiacetylene coatings to add ligands or substrates, such as antibodies, other proteins, peptides, phages, viruses, nucleic acids, aptamers, DNA and/or RNA sequences, calixarenes, cyclodextrans, etc, or to cross-link groups at the surface, or to alter the polarity or charge state of the surface, or to attach fluorophores or dyes including quantum dots. The ligands or substrates may be attached directly to the coating surface or via a linker. The attachment may be made through formation of a covalent bond, or through non-covalent interactions, including interactions arising from hydrogen bonding, ionic and dipole interactions, and van der Waal forces.

Such methods of modification are well known in the fields of polymer surface modification, solid-state synthesis and bioconjugation. Such works as “Bioconjugate Chemistry” (Hermanson, G. T. Bioconjugate Techniques; Academic Press, Inc.: San Diego, 1996) and “Fmoc Solid Phase Peptide Synthesis, A Practical Approach” (Chan, W. C. and White P. D., Fmoc Solid Phase Peptide Synthesis, A Practical Approach; Oxford University Press: New York, 2000) describe suitable reactions for attaching ligands and substrates to the coating surfaces or via linkers to the surfaces, and are incorporated herein by reference. Such reactions include, but are not limited to, reactions comprising an activated carbon as part of one species (i.e. either as part of the coating, or as part of the substrate or ligand or linker) and a nucleophilic group on the other, such as couplings between thiols and maleimides, thiols and epoxides, amines and activated esters including N-hydroxysuccinimide (NHS) esters, amines and aldehydes, hydrazides and aldehydes, amines and ketones, hydroxides and activated esters including NHS esters, displacement of leaving groups such as halides, mesylates and tosylates by amines or hydroxides, etc. Amine and hydrazide couplings with aldehydes may include a subsequent reduction step. One method particularly suitable for the attachment of amine containing ligands or substrates to coatings comprising carboxylic acid surface groups is to treat the coating two times with sulfo-NHS combined with 1-ethyl-3-(3-dimethylaminopropyl)carbodiimide hydrochloride (EDC) prior to reaction with the amine containing ligand or substrate.

Examples of suitable multiple atom linkers between the coatings and ligands or substrates include, but are not limited to, hydrocarbon chains (typically 1-22 carbon atoms), cyclohexyl groups, aromatic groups (typically hydrocarbon or hetero rings containing 5-12 carbons and more typically phenyl), oligio(ethylene glycol)s and combinations thereof. The linkers may be hetero-functional (i.e., with different reactive groups at the linker termini). Examples of suitable terminal functional groups for the multiple atom linkers include, but are not limited to, carboxylic acids, aldehydes, esters, NHS-esters, sulfo-NHS esters, amines, thiols, maleimides, epoxides, alcohols, alkoxides, halides, ammoniums, azides, mesylates, tosylates, hydrazides, and any other functional group that can be displaced or substituted. Some specific multiple atom linkers appropriate for the materials and methods of this disclosure include, but are not limited to, amino-dPEG₄™ acid, thiol-dPEG₄™ acid, amino-dPEG₈™ acid, thiol-dPEG₈™ acid, maleimide-dPEG₄™ NHS, maleimide-dPEG₈™ NHS, bis(sulfosuccinimidyl)suberate, disuccinimidyl glutarate, N-(e-maleimidocaproyloxy)sulfosuccinimide ester, and N-(g-maleimidobutyryloxy)sulfosuccinimide ester.

An advantage of post-deposition addition of ligands and substrates to the coatings over incorporation of the ligands and substrates with the diacetylene particles prior to deposition, is that the ligands or substrates are more likely to be incorporated primarily at the surface of the coating instead of being also significantly present in the coating interior, as is likely when the diacetylene particles incorporate the ligands and substrates before deposition. This may allow the use of smaller quantities of ligands and substrates thus conserving expensive and specialized materials.

The polydiacetylene coatings disclosed here appear to be appropriate for maintaining the activity of antibodies incorporated in them, as shown by sandwich immuno assays performed on coatings prepared from diacetylene liposomes with antibodies deposited on poly-D-lysine treated MCE membranes, over a 13 month period.

Also, coatings made from partially aggregated particles according to this disclosure may be particularly self-cohesive.

These coatings may be used for the detection of an analyte in a sample, which comprises contacting the sample to be tested with the coating as disclosed above;
and detecting the change in fluorescence or phosphorescence to indicate the presence of the analyte. When to be employed for this purpose, the array has incorporated therein a substrate or ligand that has direct affinity for an analyte or can function as a binder to an analyte or can react with an analyte.

The polydiacetylene coatings of this disclosure may incorporate non-diacetylene lipids and be exposed to small molecules; the change in the polydiacetylene emission is then correlated to the small molecules' drug like properties (lipophilicity, membrane permeation, tissue uptake, volume of distribution, blood brain barrier penetration etc). Alternatively, the change in the polydiacetylene coatings of this disclosure upon exposure to solution of small molecules may be used to detect the presence and with suitable calibration, the concentration of the small molecules. The polydiacetylene coatings of this disclosure may be at the start of the assay in either a non-fluorescent or fluorescent state; the emission may either rise or fall in response to interaction with the small molecules.

As discussed above, the coatings of this disclosure can be used for detecting of an analyte in a sample by measuring a change in fluorescence and/or phosphorescence. Also, the coatings of this disclosure can be used for evaluating at least one of the ionization state of a compound, the organic/water partition coefficient and lipophilicity, oral absorption, the volume of distribution of a compound, the distribution of a compound into different tissues, the ability of a compound to diffuse into cell membranes and the partitioning of a compound into cell organelles, by measuring the effect on the array by detecting the change in fluorescence or phosphorescence.

Another aspect of the present disclosure is concerned with a method for detecting a plurality of different species. The present disclosure provides a method for screening a plurality of samples containing different species, which comprises exposing a coating of this disclosure to the samples to be evaluated; wherein the coating is capable of hetero-detection (i.e., the coating is capable of detecting multiple species):

detecting the change in fluorescence or phosphorescence of the coating, and

comparing the change to a previously determined change in fluorescence or phosphorescence of the coating to determine whether the species are present in the samples. In a further refinement, comparison with calibration curves allows determination of the concentration of the species.

Another aspect of the present disclosure is concerned with a method for evaluating at least one of the ionization state of a compound, the organic/water partition coefficient and lipophilicity, oral absorption, the volume of distribution of a compound, the distribution of a compound into different tissues, the ability of a compound to diffuse into cell membranes and the partitioning of a compound into cell organelles, which comprises exposing any of the above disclosed coatings to the compound to be evaluated; and

measuring the effect on the array by detecting the change in fluorescence or phosphorescence of the coatings.

The porous nature of the coated membranes allows filtration through and past the sensing coating making them particularly suited for use in methods of testing water, for contaminants including microorganisms, toxins, and poisons. The coatings of this disclosure are suitable for incorporation into devices for testing water solutions.

Examples of some analyte and substrate or ligand systems that can be used in the present disclosure are as follows:

The analyte is an enzyme and the substrate or ligand is a reactive substrate of that enzyme.

The analyte is an antigen and the substrate or ligand is the antibody of that antigen.

The analyte is an antigen and the substrate or ligand is a fragment of the antibody of that antigen.

The analyte is an antibody or antibody fragment and the substrate or ligand is the antigen of that antibody.

The analyte is an antibody or antibody fragment and the substrate or ligand is the epitope of that antibody.

The analyte is a microorganism and fragment thereof and the substrate or ligand is a phage particle.

The analyte is a microorganism and fragment thereof and the substrate or ligand is a nucleic acid aptamer.

The analyte is a microorganism and fragment thereof and the substrate or ligand is a peptide.

The analyte is a microorganism and fragment thereof and the substrate or ligand is a peptide.

The analyte is a protein and the substrate or ligand is a phage particle.

The analyte is a protein and the substrate or ligand is a nucleic acid aptamer.

The analyte is a protein and the substrate or ligand is a peptide.

The analyte is a protein and the substrate or ligand is a peptide.

The analyte is a nucleic acid sequence and the substrate or ligand contains a complimentary nucleic acid sequence capable of hybridization with the analyte.

The following non-limiting examples are presented to further facilitate an understanding of the present disclosure:

In the following examples, unless otherwise stated, the diacetylene fatty acids are purchased from GFS or synthesized in-house. Acetylene compounds are purchased from GFS or Lancaster. Reagents are obtained from Sigma Aldrich, Fisher Scientific, Pierce and Quanta Biodesigns. Organic fluorophores are obtained from Invitrogen (formerly Molecular Probes). Fluorophores include: 5-(((4-(4,4-difluoro-5-(2-thienyl)-4-bora-3a,4a-diaza-s-indacene-3-yl)phenoxy)acetyl)amino)pentylamine hydrochloride (BODIPY® TR cadaverine) (1) and 1,1′-dioctadecyl-3,3,3′,3′-tetramethylindodicarbocyanine, 4-chlorobenzenesulfonate salt (DIC-18(5)) (2), and are added to lipid formulations at 1 fluorophore:200 lipids. 1,2-Dimyristoyl-sn-glycero-3-phosphatidylcholine (DMPC), and 1,2-Dioleoyl-sn-glycero-3-phosphocholine (DOPC), 1-palmitoyl-2-oleoyl-sn-glycero-3-phosphatidylcholine (POPC) are purchased from Avanti Polar Lipids. N-(4-(p-Maleimidophenyl)butyryl)-1,2-distearoyl-sn-glycero-3-phosphoethanolamine, sodium salt (MPB-DSPE) is purchased from Northern Lipids Inc. A ricin binding aptamer sequence (Kirby R. et al., Anal. Chem. 2004, 76(14), 4066-4075) with an amine terminated hexyl linker attached to the 5′ end is synthesized by IDT. A ricin binding peptide sequence (Khan A. S. et al., Biotech Lett. 2003, 25, 1671-1675) with an additional glycine at the amine end is synthesized by Biosynthesis Inc. Anti Bacillus globigii (BG) polyclonal antibodies are obtained from the U.S. Department of Defense JPED-CBD Critical Reagents Program. Anti C. parvum oocysts polyclonal antibodies are obtained from the NIH AIDS Reagent Program (originally donated by Dr. Joseph Crabb). The antibodies are purified by size exclusion chromatography in 0.1M sodium phosphate/0.1M sodium chloride at pH 7.0, and stored frozen at 4.35 mg/mL. Goat anti-E. coli antibodies are obtained from Virostat, Inc., and rabbit anti-E. coli antibodies are obtained from Biodesign. Asialofetuin Type I is obtained from Sigma-Aldrich. Water is deionized to a final resistance of >17.5 MΩ and sterilized with UV light (Aurora). Membranes and filter plates are purchased from Fisher Scientific, with the exception of Pall AcroPrep 96-well plates with GHP (hydrophilic polypropylene) membranes, which are obtained directly from Pall Corporation, and custom plates manufactured for us by Millipore with 100μ MCE membranes. Plasma treatment of membranes and filter plates is performed by Plasmatech Inc.

Buffers used include PBS (10 mM sodium phosphate/138 mM sodium chloride/2.7 mM potassium chloride) at pH 7.4; MES (0.1M 2-(N-morpholine)-ethane sulphonic acid) at pH 6.0; and TBS (50 mM 2-amino-2-hydroxymethyl-1,3-propanediol (TRIS)/138 mM sodium chloride/2.7 mM potassium chloride) at pH 7.4.

Diacetylene fatty acids that are not commercially available are synthesized according to literature methods by the copper (I) mediated coupling of the appropriate 1-iodo-1-yne hydrocarbon and ω-yne carboxylic acid (Tieke B. et al, Angew. Chem Int. Ed. Eng., 1976, 15(12), 764-765). 2-hydroxyethyl 10,12-pentacosadiynamide (P-EtOH) (Spevak et al, J. Am. Chem. Soc. 1993, 115, 1146-1147) and mono 10,12-pentacosadiynyl phosphate (P—PO4) (Hub H-H.; Hupfer B.; Koch H.; Ringsdorf H., Angew. Chem. Int. Ed. Engl., 1980, 19(11), 938-940) are synthesized by literature methods.

1-Amino-10,12-pentacosadiyne (P—NH₂) is synthesized in four steps from 10,12-pentacosadiynoic acid: the acid in anhydrous tetrahydrofuran at 0° C. is reduced to the alcohol through treatment with lithium aluminum hydride (2.5 equivalents) in ether for two hours, the alcohol is then converted to the mesylate by treatment with mesyl chloride (6 equivalents) in methylene chloride with diisopropyl ethyl amine over 30 minutes, the mesylate is displaced by sodium azide (1.5 equivalents) in dimethyl formamide at 70° C. over one hour and the azide in tetrahydrofuran is reduced to the amine with lithium aluminum hydride (2 equivalents) in ether at 0° C. over one hour. The amine is dissolved in ethanol and treated with aqueous hydrochloride to convert it to the hydrochloride salt for storage.

N-(10,12-pentacosadiynyl)-glutaramic acid (P-GA) is prepared from P—NH₂ as follows: P—NH₃Cl is reacted with glutaric anhydride (2 equivalents) in DMF, in the presence of diisopropylethylamine (3 equivalents), at 70° C. for 1 hour and the crude product recrystallized from a mixture of chloroform and hexanes. 2-aminoethyl 10,12-pentacosadiynamide (P-EtNH₂) is synthesized by the reaction of the NHS ester of 10,12-pentacosadiynoic acid prepared according to Spevak et al (Spevak et al, J. Am. Chem. Soc. 1993, 115, 1146-1147) with 1,2-ethylene diamine (1.3 equivalents) in methylene chloride for one hour. The product is purified by recrystallization from hexane followed by chromatography on silica with chloroform/methanol/diisopropyl ethyl amine eluent (89/10/1).

N,N-bis-2-(10,12-hexacosadiynoyl)ethyl dimethylammonium iodide (BHDMAI) is synthesized from 10,12-hexacosaidynoic acid according to the method of Hub et al (Hub et al. Angew. Chem. Int. Ed. Engl. 1980, 19(11), 938-940). Briefly, 10,12-hexacosadiynoic acid is converted into the acid chloride by reaction with 20 equivalents of thionyl chloride in methylene chloride at reflux over 30 minutes. The excess thionyl chloride is removed under reduced pressure and the acid chloride reacted with N-methyldiethanolamine (0.48 equivalents) in methylene chloride in the presence of diisopropylethyl amine (1.2 equivalents) over three days. The resulting N,N-bis-2-(10,12-hexacosadiynoyl)ethyl methylamine is recrystallized from hexane and reacted with methyl iodide (1 equivalent) in methylene chloride over two days. The crude product is recrystallized from a mixture of chloroform and hexanes.

Anti-BG phage are developed in-house according to the following methods. A Ph.D-0.7 Phage Display Peptide Library Kit containing a random displayed 7-mer library fused to the M13 phage, host E. coli K12 ER2738, and appropriate sequencing primers are purchased from New England Biolabs. The 7-mer phage display peptide library (complexity 2.8×10⁹ sequences) is screened according to a literature procedure (Knurr J. et al, Appl. Environ. Microbio., 2003, 69(11), 6841-6847) using gravity centrifugation to collect spore-phage complexes. Double washed B. globigii spores (2×10⁹) are mixed with the library phage (2×10¹¹) in 1 mL of sterile filtered TBST (50 mM Tris, 150 mM NaCl, 0.5% Tween-20, pH 7.5) and allowed to bind for 10 minutes at room temperature. Spore-phage complexes are collected by gravity centrifugation (12,000×g) for 10 minutes at 4° C. The supernatant is decanted and the complexes are washed 10× with ice-cold TBST. A sample from the fifth wash is saved in order to assess the amount of non-specific phage virions that are washed from the complexes. Specific phage virions are eluted from the spore-phage complexes with the addition of 1 ml elution buffer (0.2 mM glycine-HCl, 1 mg/ml BSA, pH 2.2) and then gently rocked for 5 minutes at room temperature. A final centrifugation for 5 minutes isolated the eluted phage, which is retained in the supernatant. This eluted phage is transferred to a fresh microcentrifuge tube and 150 μl of 1 M Tris-HCl pH 9.1 is added to neutralize the phage. The eluted phage is amplified according to manufacturer's protocol and a titer of each stock is determined. The first round's amplified phage is used as the input phage in round two. The entire procedure is repeated for three rounds total of biopanning. Twenty clones from each method are selected for sequencing and analysis. Genomic ssDNA is extracted and purified also according to the manufacturer's protocol and templates sent for DNA sequence analysis (GeneWhiz).

Probe sonication is achieved with Biologics 300 V/T Ultrasonic homogenizer fitted with an intermediate tip. Photopolymerization is achieved using a UV-oven capable of delivering calibrated energy doses of UV light around 254 nm. ¹H and ¹³C spectra to confirm compound identity are obtained by Acorn NMR, Livermore CA.

Diacetylene particle solutions are prepared according to general methods presented in the literature (Hupfer B. et al, Chem. Phys. Lipids, 1983, 33, 355-374; Spevak et al, J. Am. Chem. Soc., 1993, 115, 1146-supplementary materials; Reichart A. et al. J. Am. Chem. Soc., 1995, 117, 829-supplementary materials) by drying organic solutions of the diacetylene surfactants together with any lipophilic additives including fluorophores, adding water or buffer to bring the combined materials to circa 1 mM overall, probe sonication to disperse the materials and immediate filtration through a 0.8 μm pore size cellulose acetate filter. The particle solutions are cooled to room temperature and then at 10° C. prior to deposition.

Diacetylene coatings are protected from ambient light exposures longer than 5-15 minutes. The amount and activity of antibodies displayed at the surface is evaluated through enzyme-linked immunosorbant assays (EIA) using an appropriate secondary antibody linked to an enzyme, preferably alkaline phosphatase (Pindzola B. A. et al. Chem. Comm. 2006, 906-908). The coatings are blocked with BSA and exposed to the secondary antibody enzyme conjugate. A luminescence substrate for the enzyme is added and the light output measured. Light output from coatings without antibodies is subtracted to adjust for non-specific binding of the secondary antibody-enzyme conjugate.

### EXAMPLE 1

96-well mixed cellulose ester, polycarbonate, hydrophilic polypropylene or hydrophilic PVDF (Durapore) filter plates (pore sizes 0.1 to 0.45μ) are charged with 60-100 μL/well of a 0.1 mg/mL poly-D-lysine solution (mw 70,000-150,000) or 0.1 mg/mL poly-L-glutamic acid sodium salt (mw 50,000-100,000) solution in water. The plates are incubated at room temperature for three hours and the solution is decanted. The plates are air dried overnight.

### EXAMPLE 2

96-well mixed cellulose ester, polycarbonate, hydrophilic polypropylene, or hydrophilic PVDF (Durapore) (pore sizes 0.1 to 0.45μ) are charged with 100 μL/well of a 0.1 mg/ml poly-D-lysine solution in water. The plates are incubated at room temperature for three hours and the solution is decanted. The plates are air dried overnight. Each well is then filled with 275 μL of a 1% bovine serum albumin solution (BSA) prepared in PBS pH 7.4. The plates are incubated at room temperature for three hours and then decanted and air dried overnight with the plate turned upside down.

### EXAMPLE 3

Free-standing cellulose ester, polycarbonate, or hydrophilic PVDF (Durapore) filter membranes (pore sizes 0.1 to 0.45μ) are soaked in a 0.1 mg/mL poly-D-lysine solution (mw 70,000-150,000) or 0.1 mg/mL poly-L-glutamic acid sodium salt (mw 50,000-100,000) solution in water for three hours, blotted dry on one side with a paper towel and left to air dry on a paper towel overnight.

### EXAMPLE 4

Free-standing cellulose ester, polycarbonate, or hydrophilic PVDF (Durapore) filter membranes (pore sizes 0.1 to 0.45μ) are soaked in a 0.1 mg/mL poly-D-lysine (mw 70,000-150,000) solution in water for three hours, blotted dry on one side with a paper towel and left to air dry on a paper towel or filter paper overnight. The membranes are then soaked in 1% BSA in PBS at pH 7.4 for three hours. The membranes are blotted dry on one side and left to air dry on a paper towel or filter paper overnight.

### EXAMPLE 5

MCE filter membranes (0.45 μm) are soaked in 20 mM poly(acrylic acid)/0.5M NaCl pH 4 (PAA) for five minutes and then rinsed in H₂O with gentle shaking for two minutes. The membranes are then soaked in 20 mM poly(allylamine HCl)/0.5M NaCl (PAH) at pH 4, then rinsed again in H₂O with gentle shaking for two minutes. This process is repeated two more times, followed by a final soaking in PAA with a H₂O rinse, to generate a [PAA/PAH]₃PAA multilayer.

### EXAMPLE 6

A Northern Lipids Inc 10 mL Thermobarrel extruder is assembled with a pre-wetted 1″ MCE membrane (0.1μ pores) placed on the mesh disc with a Teflon gasket (Fisherbrand, catalog no. 09-753-23B) on top. A flat Teflon gasket (Fisherbrand, catalog no. 09-753-21B) is placed between the mesh disk and the filter support disk. A solution of diacetylene particles composed of P-EtOH/P-GA/DMPC/1 in a 50/30/20 ratio at 1 mM total lipid in water (2 mL) is added to the extruder and a negative pressure of 350 Torr applied to the extruder outlet. Filtration occurs with clear filtrate coming through the membrane; negative pressure is held until all lines are clear. Photopolymerization of the membrane with 0.02 μJ/cm² of UV light around 254 nm produces a deep blue coating.

### EXAMPLE 7

A Northern Lipids Inc 10 mL Thermobarrel extruder is assembled with a 1″ MCE membrane, pretreated with polylysine and BSA as described in Example 4 and pre-wetted, placed on the mesh disc with a Teflon gasket (Fisherbrand, catalog no. 09-753-23B) on top. A flat Teflon gasket (Fisherbrand, catalog no. 09-753-21B) is placed between the mesh disk and the filter support disk. A solution of diacetylene particles composed of P—PO₄/1 (1 mM total lipid) in water (2 mL) is added to the extruder and a negative pressure circa 25 Torr applied to the extruder outlet. Filtration occurs with clear filtrate coming through the membrane; negative pressure is held until all lines are clear. Photopolymerization of the membrane with 0.02 μJ/cm² of UV light around 254 nm produces a medium blue coating.

### EXAMPLE 8

A Northern Lipids Inc 10 mL Thermobarrel extruder is assembled with a 1″ MCE membrane (0.45 μpores), with (PAA/PAH)PAA multilayers deposited as described in Example 5, and pre-wetted, placed on the mesh disc with a Teflon gasket (Fisherbrand, catalog no. 09-753-23B) on top. A flat Teflon gasket (Fisherbrand, catalog no. 09-753-21B) is placed between the mesh disk and the filter support disk. A solution of diacetylene particles composed of P-EtOH/P-GA/DMPC/1 in a 50/30/20 ratio (1 mM total lipid) in water (2 mL) is added to the extruder and a negative pressure circa 25 Torr applied to the extruder outlet. Filtration occurs with clear filtrate coming through the membrane; negative pressure is held until all lines are clear. The coated membranes are held at 4° C. overnight.

A solution of 48.9 mg 1-ethyl-3-(3-dimethylaminopropyl)carbodiimide hydrochloride (EDC) and 8.24 mg sulfo-NHS in 16 mL MES is prepared and 4 mL/membrane added to the coated membranes, each membrane in the well of a 6-well plate. The plate is shaken for 10 minutes, the membranes removed and the solution dumped. The membranes are replaced in the wells and a second freshly prepared EDC/NHS/MES solution added and the plate shaken and dumped as before. The membranes are rinsed with MES and put into a new plate holding 4 mL/well PBS pH 7.4. 12.3 μL of 6.5 mg/mL rabbit anti-E. coli antibodies are added to each well and the plate shaken for 3 hours. The membranes are washed with PBS three times and stored in PBS at 4° C. overnight. Photopolymerization with 0.04 μJ/cm2 produces blue coatings. Smaller circles of coated membrane are punched out and placed in a custom holder.

### EXAMPLE 9

A 1″ MCE membrane (0.45 μpores), with (PAA/PAH)PAA multilayers deposited as described in Example 5 and pre-wetted with H₂O is placed in a Fisherbrand syringe holder that is then mounted on a plastic syringe charged with 2 mL of P-EtOH/P-GA/DMPC/1 in a 50/30/20 ratio (1 mM total lipid) in water. The syringe plunger is used to push the liquid through the membrane; the filtrate is collected and re-filtered through the membrane two more times. The coated membrane is chilled overnight and further functionalized with EDC/sulfo-NHS and antibodies and polymerized as described in Example 8.

### EXAMPLE 10

The membranes of a Millipore MCE filter plate (0.05μ pores) are pre-wetted by filtration of H₂O and charged with diacetylene particles composed of 90% 10,12-pentacosadiynoic acid (PCDA)/10% MPB-DSPE/1. The plate is filtered after 3-5 minutes using a Millipore plate filtration manifold and a negative pressure of circa 250 Torr, and held at 4° C.

Bovine anti C. parvum oocysts polyclonal antibodies (7.6 mg) are reacted with N-succinimidyl-3-(2-pyridyldithio)propionate (SPDP, 54 μg) for 1 hour in 0.1 M sodium phosphate/0.15 M sodium chloride at pH 7.2. The reaction is then dialyzed against 0.1 M sodium acetate/0.15 M sodium chloride at pH 4.5 three times. The antibody-SPDP conjugate (0.5 mg antibody) solution is sparged with argon and reduced with dithiothreitol (DTT, 0.4 mg) for 30 minutes to generate the free thiol. The solution is then dialyzed against argon sparged 0.1M sodium phosphate/0.15M sodium chloride/10 mM ethylenediaminetetraacetic acid (EDTA), with continuous argon sparging, three times.

The wells of the plate with coated membranes are charged with 100 μL of the antibody-thiol solution at 0.1 mg/mL under a nitrogen atmosphere. The plate is sealed with a tape cover and shaken overnight. The reaction solution is then dumped and the wells washed with TBS four times. The plate is chilled at 4° C. for 40 minutes and photopolymerized with 0.03 μJ/cm² of UV light around 254 nm to produce even medium blue coatings.

### EXAMPLE 11

Wells of a 96-well MCE Millipore filter plate (0.45 μpores) pretreated with poly-D-lysine and BSA as described in Example 2 are charged with 100 μL/well of diacetylene particles composed of 70% P-EtOH/10% DMPC/30% P-GA/1. The plate is filtered with a negative pressure of 350 Torr and the plate stored at 4° C. overnight.

Sulfo-NHS and EDC (33.3 and 5.4 mg) are dissolved in 11 mL MES and the solution promptly added to the coated wells (100 μL/well). The plate is shaken for 10 minutes, the solution dumped and the procedure repeated with a fresh sulfo-NHS/EDC solution. The wells are washed once with MES (200 μL/well) and then charged with either 1 μg/well of rabbit anti-BG antibodies in PBS (100 μL/well). The plate is shaken for 3 hours, dumped and the wells washed three times with PBS (200 μL/well per wash). The wells are charged with 150 mM cesium chloride/10 mM sodium phosphate at pH 7.4 and the plate kept at 4° C. overnight. The buffer is then filtered through the plate with a negative pressure of 350 Torr and the coatings photopolymerized with 0.1 μJ/cm² of UV light around 254 nm to give medium blue coatings.

### EXAMPLE 12

Wells of a 96-well AcroPrep Pall filter plate (hydrophilic polypropylene, 0.45μ pores) pretreated with poly-D-lysine and BSA as described in Example 2 are charged with 100 μL/well of diacetylene particles composed of 80% 10,12-PCDA/30% P-GA/2. The plate is filtered with a negative pressure of 300 Torr and chilled at 4° C. for 3.5 hours.

The coatings are treated with sulfo-NHS/EDC/MES solutions twice and washed with MES as described in Example 11. The wells are then charged with 1 μg/mL asialofetuin in PBS (100 μL/well) and the plate shaken for three hours. The solution is dumped and the plate washed with PBS three times and stored at 4° C. for five days. Photopolymerization of the plate with 0.2 μJ/cm² of UV light around 254 nm gives bright blue coatings.

### EXAMPLE 13

Wells of a 96-well MCE Millipore filter plate (0.45 μpores) pretreated with poly-D-lysine and BSA as described in Example 2 are charged with 100 μL/well of diacetylene particles composed of 96% P-EtOH/4% P-GA/1. The plate is chilled at 4° C. for 30 minutes then filtered. The plate is chilled at 4° C. for 2.5 hours in a humid atmosphere and then treated with sulfo-NHS/EDC/MES solutions twice and washed with MES as described in Example 11. The wells are then charged with the ricin binding aptamer hexyl amine in MES, at 0.25 μg/well and the plate shaken for three hours. The solution is dumped and the plate washed three times with MES. The plate is stored overnight at 4° C. and photopolymerized with 0.08 μJ/cm² of UV light around 254 nm to give deep blue coatings.

### EXAMPLE 14

Wells of a 96-well MCE Millipore filter plate (0.45 μpores) pretreated with poly-D-lysine and BSA as described in Example 2 are charged with 100 μL/well of diacetylene particles composed of 80% 10,12-PCDA/20% P-GA/2. The plate is chilled at 4° C. for 30 minutes then filtered with a negative pressure of 350 Torr. The plate is chilled for 3.5 hours then treated with sulfo-NHS/EDC/MES solutions twice and washed with MES as described in Example 11. The wells are then charged with anti-BG phage in PBS at 3.5×10¹¹ per well (100 μL) and the plate shaken for three hours. The solution is dumped and the wells washed three times with PBS. The plate is stored at 4° C. overnight. Photopolymerization of the plate with 0.3 μJ/cm² of UV light around 254 nm gives medium blue coatings.

### EXAMPLE 15

Wells of a 96-well MCE Millipore filter plate (0.45 μpores) pretreated with poly-D-lysine and BSA as described in Example 2 are charged with 100 μL/well of diacetylene particles composed of 90% P-EtOH/30% P-GA. The plate is chilled at 4° C. for 33 minutes then filtered with a negative pressure of 350 Torr. The plate is kept in humid conditions at 4° C. overnight then treated with sulfo-NHS/EDC/MES solutions twice and washed with MES as described in Example 11. The wells are then charged with 0.5 μg ricin binding peptide in PBS (100 μL) and the plate shaken for three hours. The solution is dumped and the wells washed three times with PBS. The plate is stored at 4° C. overnight in humid conditions. Photopolymerization of the plate with 0.1 μJ/cm² of UV light around 254 nm gives medium blue coatings.

### EXAMPLE 16

The wells of a 96-well polycarbonate membrane Millipore filter plate (0.4μ pores) are pretreated as follows: row A & B no treatment; rows C & D poly-D-lysine treatment; rows E & F BSA treatment and rows G & H poly-D-lysine treatment followed by BSA treatment. The poly-D-lysine solution (0.1 mg/mL, 100 μL/well) is added to the appropriate wells, the plate sits for three hours, then the solution dumped out and the plate dries overnight. BSA (1% in PBS, 275 μL/well) is then added to the appropriate wells, the plate sits for three hours, then the solution is dumped out and the plate dries overnight. The wells are charged with diacetylene particles composed of 70% 10,12-PCDA/30% POPC/1. POPC is a substrate for ricin lipase activity (Lombardo W. et al. Biochem J. 2001, 358, 773-781; Helmy M. et al. Biochem. Biophys. Res. Commun. 1999, 258(2), 252-255). The plate is chilled at 4° C. for 30 minutes then filtered with reduced pressure of 350 Torr. The plate is stored at 4° C. under humid conditions overnight, then photopolymerized with 0.1 J/cm² of UV light around 254 nm to produce blue coatings. The coatings on the wells treated with poly-D-lysine only are less even than the other coatings.

### EXAMPLE 17

Two Millipore 96-well filter plates, one with MCE membranes (0.45μ pores) and the other with hydrophilic PVDF membranes (0.45 μl pores), are treated with poly-L-glutamic acid sodium salt in columns 1-4, poly-D-lysine hydrobromide in columns 5-8, and columns 9-12 with H2O (i.e., untreated) for 3.5 hours. The solutions are dumped and the plates dried overnight. The wells of the plates are charged with diacetylene particles of different compositions: rows A and E with 10,12-PCDA; rows B & F with P—PO₄; rows C and G with 60% 10,12-tricosadiynoic acid/30% DMPC; and rows D and H with BHDMAI. Rows A-D are filled and the plates chilled for 30 minutes at 4° C., rows E-H are then filled and the plates filtered with reduced pressure of 350 Torr. The filtrates are collected in white 96-well plates. The plates and filtrates are chilled for 30 minutes at 4° C. and photopolymerized with 0.02 J/cm² of UV light around 254 nm. FIGS. 1a-d show the polymerized plates and filtrates. The BHDMAI (composed of positively charged diacetylenes) only coated on the poly-L-glutamic acid treated membranes. The 10,12-PCDA and P—PO₄ diacetylenes only coated onto the poly-D-lysine treated membranes.

### EXAMPLE 18

Goat anti-E. coli polyclonal antibodies from Virostat (3.1 mg in 500 μL buffer) are reduced with 2-mercaptoethanol (MEA) in the presence of EDTA (58 mM MEA/66 mM EDTA in water, argon sparged, 500 μL) over 3 hours. The solution is dialyzed three times against argon sparged 5 mM sodium acetate/50 mM sodium chloride/10 mM EDTA at pH 4.7. The free thiol groups are used to conjugate the antibody to 1,2-distearoyl-sn-glycero-3-phosphorylethanolaminocarproylmaleimide (PE-M) through addition of PE-M in DMSO (72.8 μL of 5.32 mM solution) and shaking under argon at 37° C. overnight. The reaction solution is dialyzed against 1.5 mM potassium phosphate/1 mM sodium phosphate/138 mM sodium chloride/2.7 mM potassium chloride at pH 7.1 three times.

The modified antibodies (148 μL at 1.9 mg/mL) are combined with a solution of 10,12-PCDA particles (15 mL), deoxycholate solution (12.5% in water, 0.85 mL) and 1.5 mL of 15 mM potassium phosphate/10 mM sodium phosphate/1.37M sodium chloride/27 mM potassium chloride at pH 7.4. The mixture is then dialyzed at 4° C. against 1.5 mM potassium phosphate/1 mM sodium phosphate/10 mM potassium chloride at pH 7.4 three times. The solution is held at 4° C. for 6 weeks.

A 96-well filter plate with MCE membranes (0.1μ pores), manufactured as a custom item by Millipore Inc, is treated with plasma gas using a proprietary process (#4387) by Plasmatech Inc to graft amine groups upon the surface. A second plate is treated, also by a proprietary process (#4388), to graft oxygen containing groups such as ethers, alcohols, ketones, aldehydes, esters, acids and carbonates (according to Plasmatech), upon the surface. An untreated plate is included in the experiment for comparison. The plate membranes are prewetted and the wells charged with the diacetylene-antibody particles (100 μL/well) or with diacetylene (no antibody) particles. The plates are filtered with a reduced pressure of 421 psi. The coated membranes are then exposed to 0.03 J/cm² of UV light around 254 nm to produce blue coatings.

EIA analysis of the coated membranes show that the amount of secondary antibody-enzyme bound to the PDA-Ab coatings, adjusted for non-specific binding using data from plain PDA coatings, is, in order: amine grafted membranes (highest)>oxygen grafted membranes>plain membranes (lowest). The emission of the coatings on the amine grafted membranes remained stable for a week and then rose; the emission of the coatings on the other membranes remained stable over two weeks.

### EXAMPLE 19

Bovine anti-C. parvum oocyst antibodies are reacted with 2-iminothiolane to generate surface thiols as follows: 1.7 mL antibody (1.8 mg/mL) is combined with 10 μL 9.4 mM (5 equivalents) 2-iminothiolane in 10 mM NaPO₄ /138 mM NaCl/2.7 mM KCl pH 7.4 (PBS) and 75 μL 1 M NaHCO₃. The solution is shaken at room temperature for 1.5 h and then dialyzed (10K MWCO) against Ar-sparged PBS with 10 mM EDTA (3 changes of 1 L each) for 25 h. The free thiols on the antibodies are then reacted with the maleimide-containing tail MX-DSPE to generate the antibody-tail conjugates. 150 μL 5 mM MX-DSPE in ethanol (20 equivalents) is added to the thiol-containing antibodies and they are shaken at 37° C. for 16 h. The antibody-tail conjugates are dialyzed (10K MWCO) against PBS (3 changes of 1.2 L) for 7.5 h and stored at 4° C. until use.

Hydrophilic PVDF 1″ membranes (0.1μ pores), pretreated with poly-D-lysine as in Example 4 are dried for four hours. Diacetylene particles composed of 10,12-PCDA and P—PO₄ with solution filtered through the membrane by pushing the syringe plunger down. Similar coated membranes are prepared with 10,12-PCDA and P—PO4 diacetylene particles, with antibody-tail conjugates incorporated by detergent dialysis, as described in Example 18. The coated membranes are chilled at 4° C. for 10-35 minutes and photopolymerized with 0.03 J/cm² (10,12-PCDA coating) and 0.01 J/cm² (P—PO₄ coating) of UV light around 254 nm.

The coated membranes are put in 4% formalin in 10 mM sodium phosphate at pH 7.4 and sent to Paragon Biosciences for TEM imaging. There they are treated with biotinylated anti-bovine antibody followed by 6 nm gold particles conjugated to streptavidin. The samples are then immersed in 0.2 M sucrose and post-fixed with 1% osmium tetroxide. Following fixation, the samples are dehydrated through graded alcohols, propylene oxide and incubated in Epon and propylene oxide. They are then embedded in beam capsules and the resulting blocks are trimmed and sections cut. The sections are mounted and stained with uranyl and lead citrate. The stained grids are observed with a Zeiss EM10A/EM10B at 80 kV and pictures taken.

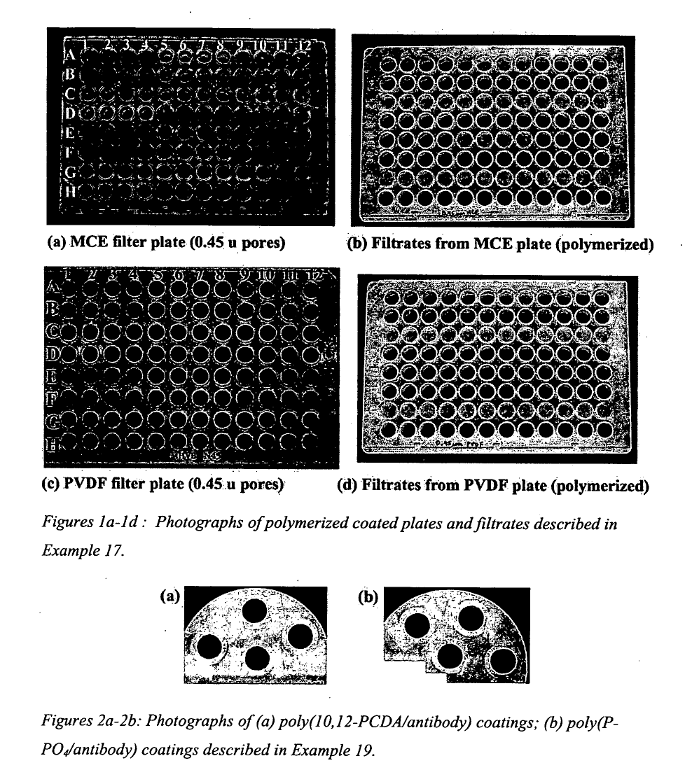

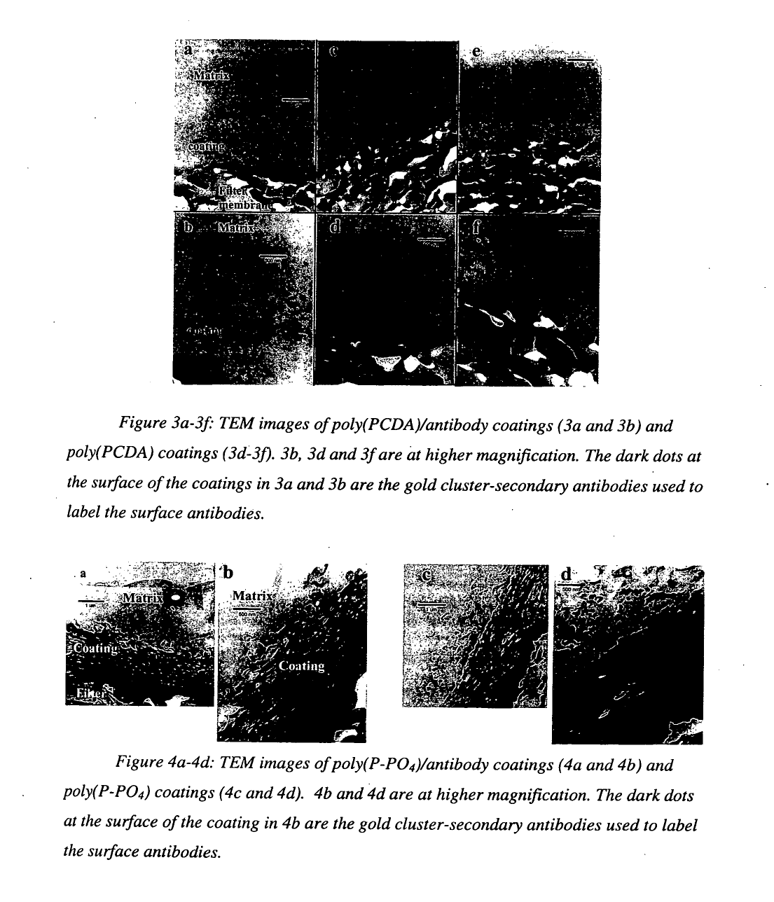

Photographs of membranes coated with PDA/antibody-tail coatings are shown in FIG. 2. TEM images of PDA/antibody-tail coatings and control PDA coatings are shown in FIGS. 3 and 4 respectively.

The term “comprising” (and its grammatical variations) as used herein is used in the inclusive sense of “having” or “including” and not in the exclusive sense of “consisting only of.” The terms “a” and “the” as used herein are understood to encompass the plural as well as the singular.

The foregoing description illustrates and describes the disclosure. Additionally, the disclosure shows and describes only the preferred embodiments but, as mentioned above, it is to be understood that it is capable to use in various other combinations, modifications, and environments and is capable of changes or modifications within the scope of the invention concepts as expressed herein, commensurate with the above teachings and/or the skill or knowledge of the relevant art. The embodiments described herein above are further intended to explain best modes known by applicant and to enable others skilled in the art to utilize the disclosure in such or other embodiments and with the various modifications required by the particular applications or uses thereof. Accordingly, the description is not intended to limit the invention to the form disclosed herein. Also, it is intended to the appended claims be construed to include alternative embodiments.

All publications and patent applications cited in this specification are herein incorporated by reference, and for any and all purposes, as if each individual publication or patent application is specifically and individually indicated to be incorporated by reference.

What is claimed is:

1. A method for fabricating a coating comprising polydiacetylene on a porous solid support which method comprises:
a) obtaining a porous solid support having a layer of polyelectrolyte on at least one major surface of the porous solid support,
b) depositing an unpolymerized precursor diacetylene onto the at least one major surface of the porous solid support having a layer of polyelectrolye to form a coating of the unpolymerized precursor diacetylene; and
c) polymerizing the unpolymerized precursor diacetylene.

2. The method according to claim 1 wherein the polymerizing comprises irradiation.

3. The method according to claim 2 wherein the irradiation is with UV light.

4. The method according to claim 1 which comprises cooling after the depositing and prior to the polymerizing.

5. The method according to claim 4 wherein said cooling is down to a temperature of about 2° C. to about 6° C.

6. The method according to claim 1 which comprises depositing the unpolymerized precursor diacetylene by pulling with a vacuum.

7. The method according to claim 6 wherein the vacuum is at a pressure of about 10 to about 650 Torr.

8. The method according to claim 6 wherein the vacuum is at a pressure of about 300 to about 400 Torr.

9. The method according to claim 6 wherein the vacuum is at a pressure of about 400 to about 650 Torr.

10. The method according to claim 1 which comprises depositing the unpolymerized precursor diacetylene by positive pressure or pushing.

11. The method according to claim 1 wherein said polyelectrolyte comprises poly(lysine).

12. The method according to claim 1 wherein said polyelectrolyte comprises multiple layers of polyelectrolyte.

13. The method according to claim 1 wherein said polyelectrolyte comprises layers of at least two different polyelectrolytes.

14. The method according to claim 1 wherein the solid support is selected from the group consisting of mixed cellulose esters, polycarbonate, hydrophilic polypropylene and hydrophilic polyvinylene difluoride.

15. The method according to claim 1 which further comprise providing a substrate or ligand that has direct affinity for an analyte or can function as a binder to an analyte or can react with an analyte.

16. A method for fabricating a coating of array of a polydiacetylene on a porous solid support which method comprises:
a) obtaining a porous solid support having a layer of polyelectrolyte on at least one major surface of the porous solid support and a layer of protein on the layer of polyelectrolyte;
b) then depositing an unpolymerized precursor diacetylene onto the at least one major surface of the porous solid support to form a coating of the unpolymerized precursor diacetylene; and
c) polymerizing the unpolymerized precursor diacetylene.

17. The method according to claim 15 wherein the polymerizing comprises irradiation.

18. The method according to claim 16 wherein the irradiation is with UV.

19. The method according to claim 16 which comprises cooling after the depositing and prior to the polymerizing.

20. The method according to claim 16 which comprises depositing the unpolymerized precursor diacetylene by pulling with a vacuum.

21. The method according to claim 20 wherein the vacuum is at a pressure of about 10 to about 650 Torr.

22. The method according to claim 20 wherein the vacuum is at a pressure of about 300 to about 400 Torr.

23. The method according to claim 20 wherein the vacuum is at a pressure of about 400 to about 650 Torr.

24. The method according to claim 16 which comprises depositing the unpolymerized precursor diacetylene by positive pressure or pushing.

25. The method according to claim 16 wherein said polyelectrolyte comprises polylysine.

26. The method according to claim 16 wherein said protein comprises bovine serum albumin.

27. The method according to claim 16 which further comprise providing a substrate or ligand that has direct affinity for an analyte or can function as a binder to an analyte or can react with an analyte.

28. The method according to claim 1 wherein said polyelectrolyte comprises a protein.

29. A method for fabricating a coating comprising polydiacetylene on a porous solid support which method comprises:
a. depositing an unpolymerized precursor diacetylene onto at least one major surface of a porous solid support to form a coating of the unpolymerized precursor diacetylene;
b. then depositing a substrate or ligand that has direct affinity for an analyte or can function as a binder to an analyte or can react with an analyte;
c. and polymerizing the unpolymerized precursor diacetylene. The substrate or ligand is deposited prior to and/or during and/or subsequent to the polymerization of the unpolymerized precursor diacetylene.

30. The method according to claim 29 wherein the substrate or ligand is coupled to the polydiacetylene via a reaction of a N-hydroxysuccinimide ester and amine.

31. The method according to claim 29 wherein the substrate or ligand is coupled to the polydiacetylene via a reaction of 1-ethyl-3-(3-dimethylaminopropyl)carbodiimide hydrochloride with a carboxylic acid followed by an amine addition.

32. The method according to claim 29 wherein the substrate or ligand is coupled to the polydiacetylene via a reaction of a sulfo-N-hydroxysuccinimide ester and 1-ethyl-3-(3-dimethylaminopropyl)carbodiimide hydrochloride

33. The method according to claim 29 wherein the substrate or ligand is coupled to the polydiacetylene via a reaction between a thiol and maleimide.

34. The method of claim 29 wherein the ligand or substrate is attached via addition of said amine to aldehyde groups forming a Schiff base.

35. The method of claim 29 wherein the ligand or substrate is attached via a Schiff base, which has been reduced to an amine.

36. A product obtained by the method according to claim 1 wherein the porous solid substrate has a pore size of at least about 0.4μ.

37. A product obtained by the method according to claim 16 wherein the porous solid substrate has a pore size of at least about 0.4μ.

38. A product obtained by the method according to claim 29 wherein the porous solid substrate has a pore size of at least about 0.4μ.

39. An article comprising a porous solid support having a layer of polyelectrolyte on at least one major surface thereof, support and a layer of protein on the layer of polyelectrolyte; and a polydiacetylene on the layer of protein, and wherein the porous solid substrate has a pore size of at least about 0.4μ.

40. An article comprising a porous solid support having a layer of polyelectrolyte on at least one major surface thereof, and a polydiacetylene on the layer of polyelectrolyte, and wherein the porous solid substrate has a pore size of at least about 0.4μ.

41. An intermediate product that comprises a porous solid support having a layer of polyelectrolyte on at least one major surface of the porous solid support and an unpolymerized precursor diacetylene located on the layer of polyelectrolyte on the at least one major surface of the porous solid support.

42. An intermediate product that comprises a porous solid support having a layer of polyelectrolyte on at least one major surface of the porous solid support, a layer of protein on the layer of polyelectrolyte and an unpolymerized precursor diacetylene located on the layer of protein.

43. An intermediate product that comprises a porous solid support having a layer of an unpolymerized precursor diacetylene located on the at least one major surface of the porous solid support; and a substrate or ligand that has direct affinity for an analyte or can function as a binder to an analyte or can react with an analyte located on the unpolymerized precursor diacetylene.

44. A product that comprises a porous solid support having a layer of a polydiacetylene located on the at least one major surface of the porous solid support; and a substrate or ligand that has direct affinity for an analyte or can function as a binder to an analyte or can react with an analyte located on the layer of a polydiacetylene.
